(19) United States
(12) Patent Application Publication
(10) Pub. No.: US 2026/0301721 A1
(43) Pub. Date: Oct. 1, 2026

(54) KEY FOR KEYBOARD DEVICE

(71) Applicant: Yamaha Corporation, Hamamatsu (JP)

(72) Inventors: Kenichi NISHIDA, Hamamatsu (JP); Akito OHBA, Hamamatsu (JP); Masaaki MITA, Hamamatsu (JP)

(21) Appl. No.: 19/573,290

(22) Filed: Mar. 20, 2026

(30) Foreign Application Priority Data
Mar. 26, 2025 (JP) 2025-051593

(51) Int. Cl. G10H 1/34

(52) U.S. Cl. CPC G10H 1/344; G10H 2220/221; G10H 2220/265

(57) ABSTRACT

A key for a keyboard device includes a first member and a second member. The first member includes a first surface configured to receive a player's operation, and a second surface that extends in a first direction intersecting the first surface. The second member is attached to the second surface via an adhesive. The first member further includes a recess that is recessed in a second direction opposite to the first direction. The recess is arranged adjacent to a region where the second member is attached to the second surface.

### CROSS-REFERENCE TO RELATED APPLICATIONS

This application claims priority to Japanese Patent Application No. 2025-051593, filed on Mar. 26, 2025. The entire disclosure of Japanese Patent Application No. 2025-051593 is hereby incorporated herein by reference.

### BACKGROUND

### Technical Field

One embodiment of this disclosure generally relates to a key for a keyboard device.

### Background Information

In general, keyboard devices such as an acoustic piano or an electronic piano use keys in which a resin material is bonded to the top surface of a wooden key body, or keys in which wood is bonded to the sides of a key body made of a resin material (Japanese published unexamined application No. 2023-163326). An adhesive is used when bonding different members in this manner. When an adhesive is used to carry out the bonding, if excess adhesive comes out onto the surface of a key (for example, at a location visible from the player) after bonding, a step to remove the excess adhesive becomes necessary, which reduces work efficiency. In order to prevent excess adhesive from coming out onto the surface of the keys, in Japanese published unexamined application No. 2023-163326, a configuration is employed in which a groove which serves as a relief space for excess adhesive is provided on the sides of each key.

### SUMMARY

When providing a groove portion that serves as a relief space for excess adhesive on the sides of keys as described in Japanese published unexamined application No. 2023-163326, it is necessary, when molding resin keys, to pull the metal mold out in the scale direction of the keys. As a result, it is difficult to reduce the size of the metal mold, or there is a limit to the number of keys that can be made in one molding process.

One object of one embodiment of this disclosure is to provide keys that can simplify the manufacturing equipment and improve productivity.

A key for a keyboard device according to one embodiment of this disclosure includes a first member and a second member. The first member includes a first surface configured to receive a player's operation, and a second surface that extends in a first direction intersecting the first surface. The second member is attached to the second surface via an adhesive. The first member further includes a recess that is recessed in a second direction opposite to the first direction. The recess is arranged adjacent to a region where the second member is attached to the second surface.

A key for a keyboard device according to one embodiment of this disclosure includes a first member and a second member. The first member includes a first surface configured to receive a player's operation, and a second surface that extends in a first direction intersecting the first surface. The second member is attached to the second surface via an adhesive. The first member further includes a recess that extends to an end of the second surface in the first direction. The recess is arranged adjacent to a region where the second member is attached to the second surface.

A key for a keyboard device according to one embodiment of this disclosure includes a key body and one or more plate-like members. The key body includes at least a top portion and a pair of side portions, and the key body has a longitudinal dimension in a front-rear direction. The one or more plate-like members are each attached via an adhesive to at least a portion of the pair of side portions of the key body. The top portion is divided into a first region and a second region that are continuously formed. The top portion in the second region protrudes from a side of the top portion in the first region across the front-rear direction. Each of the one or more plate-like members is arranged such that at least a portion of an upper end surface of at least one of the one or more plate-like members faces a lower surface of the top portion in the second region, and the top portion in the second region has a recess on the lower surface.

### BRIEF DESCRIPTION OF THE DRAWINGS

FIG. 1 is a diagram showing an overall configuration of a keyboard device according to one embodiment of this disclosure.

FIG. 2 is a block diagram showing a configuration of a sound source device according to the one embodiment of this disclosure.

FIG. 3 is a side view showing a configuration of the keyboard device according to the one embodiment of this disclosure.

FIG. 4 is a perspective view showing a configuration of a white key according to the one embodiment of this disclosure.

FIG. 5 is an exploded perspective view showing a configuration of the white key according to one embodiment of this disclosure.

FIG. 6 is a cross-sectional view of the white key according to one embodiment of this disclosure.

FIG. 7 is a cross-sectional view of a white key according to a modified example of one embodiment of this disclosure.

FIG. 8 is a cross-sectional view of a white key according to a modified example of one embodiment of this disclosure.

FIG. 9 is a side view of a white key according to one embodiment of this disclosure.

FIG. 10 is a cross-sectional view of a white key according to one embodiment of this disclosure.

FIG. 11 is a cross-sectional view of a white key according to a modified example of one embodiment of this disclosure.

FIG. 12 is a side view of a white key according to one embodiment of this disclosure.

FIG. 13 is a cross-sectional view of a white key according to one embodiment of this disclosure.

FIG. 14 is a cross-sectional view of a white key according to a modified example of one embodiment of this disclosure.

FIG. 15 is a side view of a white key according to a modified example of one embodiment of this disclosure.

FIG. 16 is a cross-sectional view showing the manner in which wood is bonded to a key in the modified example of one embodiment of this disclosure.

FIG. 17 is a cross-sectional view of a white key according to a modified example of one embodiment of this disclosure.

FIG. 18 is a cross-sectional view of a white key according to a modified example of one embodiment of this disclosure.

FIG. 19 is a cross-sectional view of a white key according to a modified example of one embodiment of this disclosure.

FIG. 20 is a cross-sectional view of a white key according to a modified example of one embodiment of this disclosure.

FIG. 21 is a cross-sectional view of a white key according to a modified example of one embodiment of this disclosure.

### DETAILED DESCRIPTION OF THE EMBODIMENTS

A keyboard device according to one embodiment of this disclosure will be described below with reference to the drawings. The following embodiments are merely examples of embodiments for implementing this disclosure, and this disclosure is not to be construed as being limited to these embodiments. In the drawings being referenced in the present embodiment, parts that are the same or that have similar functions are assigned the same symbols or similar symbols (symbols in which A, B, etc., are simply added after numbers), and redundant explanations may be omitted. Meanwhile, the dimensional proportions in the drawings (proportions between components, proportions between length, width, and height directions, etc.) may be different from the actual proportions, and some of the components may be omitted from the drawings. In the following description, the terms "up," "upward," "upper end," "down," "downward," and "lower end," may be used based on the up-down direction in each of the drawings, but the up-down direction merely describes relative directional relationships, and the up-down direction may be reversed.

As long as there is no technical contradiction, the following embodiments and modified examples thereof may be combined with other embodiments and modified examples thereof.

### 1. First Embodiment

### 1-1. Configuration of keyboard device

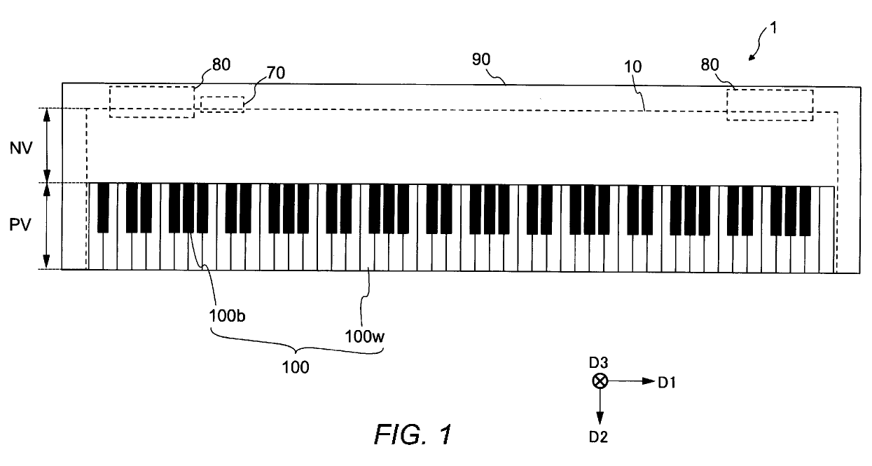

FIG. 1 is a diagram showing an overall configuration of a keyboard device according to the first embodiment. A keyboard device 1 is an electronic keyboard instrument such as an electronic piano that generates sounds in accordance with key depressions by a user (player). The keyboard device 1 can be a keyboard-type controller that outputs, in accordance with key depressions, control data (for example, MIDI) for controlling an external sound source device. In this case, the keyboard device 1 does not need to have a sound source device.

The keyboard device 1 includes a keyboard assembly 10. The keyboard assembly 10 includes white keys 100w and black keys 100b. When it is not necessary to distinguish between the white keys 100w and the black keys 100b, the keys are simply referred to as keys 100. The plurality of keys 100 are arranged side by side in the D1 direction. The plurality of keys 100 have the longitudinal dimension in the D2 direction (or the front-rear direction). The number of the keys 100 is N, which is 88 in this example. The direction in which the keys 100 are arranged is referred to as the scale direction (D1 direction). The keyboard device 1 has the longitudinal dimension in the D1 direction.

A portion of the keyboard assembly 10 is present inside a housing 90. When the keyboard device 1 is viewed from above, the portion of the keyboard assembly 10 covered by the housing 90 is referred to as a non-exterior portion NV and the portion that is exposed from the housing 90 and is visible to the user is referred to as an exterior portion PV. That is, the exterior portion PV is a portion of the keys 100 and indicates a region where the user can carry out performance operations.

A sound source device 70 and a speaker 80 are disposed inside the housing 90. The sound source device 70 generates sound waveform signals when the keys 100 are depressed. The speaker 80 outputs the sound waveform signal(s) generated by the sound source device 70 to an external space. The keyboard device 1 can be provided with a slider for controlling the volume, a switch for switching the timbre, a display for displaying various information, and the like.

In the description of the present specification, directions such as up, down, left, right, front, and rear indicate directions when the player is viewing the keyboard device 1 when playing. For example, the non-exterior portion NV can be expressed as being located further rearward of the exterior portion PV. There can be cases in which a description is provided using directions based on the keys 100, such as front end side of the keys (front side of the keys) and rear end side of the keys (rear side of the keys). In this case, the front end side of the keys indicates the front side of the keys 100 as viewed from the player. The rear end side of the keys indicates the rear side of the keys 100 as viewed from the player. According to the foregoing definition, it can be expressed that the portion from the front end to the rear end of the key body of each of the black keys 100b protrudes above the white keys 100w.

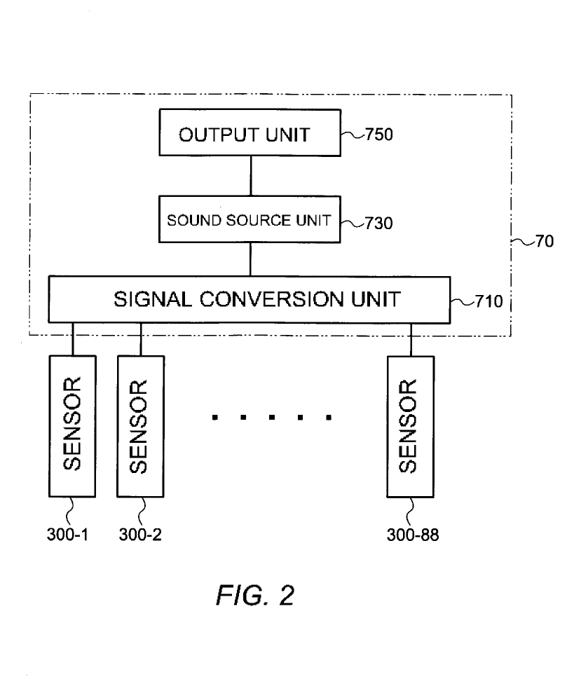

FIG. 2 is a block diagram showing a configuration of a sound source device according to the first embodiment. The sound source device 70 includes a signal conversion unit 710, a sound source unit 730, and an output unit 750. A sensor 300 is provided in correspondence with each of the keys 100, detects an operation of a key, and outputs a signal corresponding to the detected content. In this example, the sensor 300 outputs a signal in accordance with three levels of the amount of key depression. The key depression speed can be detected based on the interval between these signals.

The signal conversion unit 710 acquires an output signal from the sensor 300 (sensors 300-1, 300-2, . . . 300-88 corresponding to the 88 keys 100), and generates and outputs an operation signal corresponding to the operation state of each of the keys 100. In this example, the operation signal is a MIDI (Musical Instrument Digital Interface) format signal. The signal conversion unit 710 outputs a note-on signal in accordance with a key depression. At this time, a key number indicating which of the 88 keys 100 was operated as well as velocity corresponding to the key depression speed are output in association with the note-on signal. On the other hand, the signal conversion unit 710 outputs the key number and a note-off signal in association with each other, in accordance with a key release operation. Signals corresponding to other operations, such as pedal operations, can be input into the signal conversion unit 710 and reflected on the operation signal.

The sound source unit 730 generates a sound waveform signal based on the operation signal output from the signal conversion unit 710. The output unit 750 outputs the sound waveform signal generated by the sound source unit 730. This sound waveform signal is output to the speaker 80 or a sound waveform signal output terminal, for example.

### 1-2. Configuration of keyboard assembly

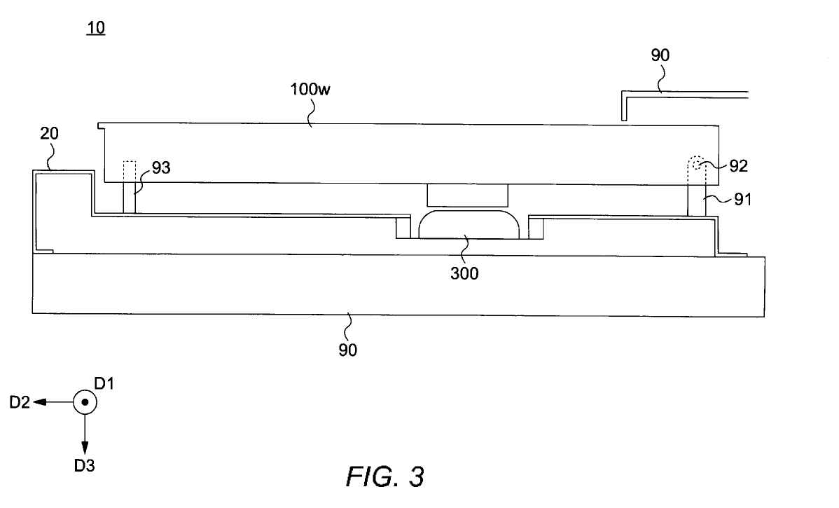

FIG. 3 is a side view showing a configuration of the keyboard device according to one embodiment of this disclosure. As shown in FIG. 3, the keyboard assembly 10 includes the white key 100w, a frame 20, the housing 90, a support part 91, a shaft 92, a guide part 93, and the sensor 300. The support part 91 and the guide part 93 are fixed to the frame 20. The shaft 92 supports the white key 100w so as to be rotatable with respect to the frame 20. In other words, the white key 100w is connected to the frame 20 so as to be rotatable (or, so as to be swingable/pivotable). The guide part 93 limits the position of the white key 100w in the D1 direction as well as the range of rotation about the shaft 92. The front end portion of the white key 100wreceives an upward force by an undiagrammed weight, spring, or the like. The sensor 300 is a sensor that detects the process by which the white key 100w moves from a rest position to an end position in accordance with a depression operation on the white key 100w, and is disposed on the lower surface side of the white key 100w in this example.

In the present embodiment, a configuration is illustrated in which the white key 100w is supported so as to be rotatable with respect to the frame 20, but the present embodiment is not limited to this configuration. The white key 100wcan be supported so as to swing with respect to the frame 20 via a flexible hinge, or the like. As long as the front end of the white key 100wcan be swung in the up-down direction by a user's key depression, the white key 100w can be supported by a configuration other than a hinge.

### 1-3. Configuration of white key 100w

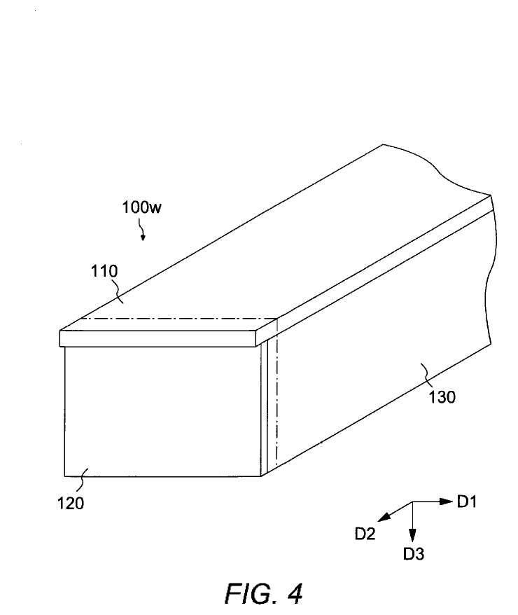

FIG. 4 is a perspective view showing a configuration of a white key according to one embodiment of this disclosure. The white key 100w includes a key top portion 110, a key front portion 120, and one or two key side plates 130. The key top portion 110 and the key front portion 120 are made of acrylic resin (PMMA resin), ABS resin, AS resin, or unsaturated polyester resin. A wooden member is used as the key side plate 130. The key top portion 110 is a member with which the user's finger comes in contact when playing.

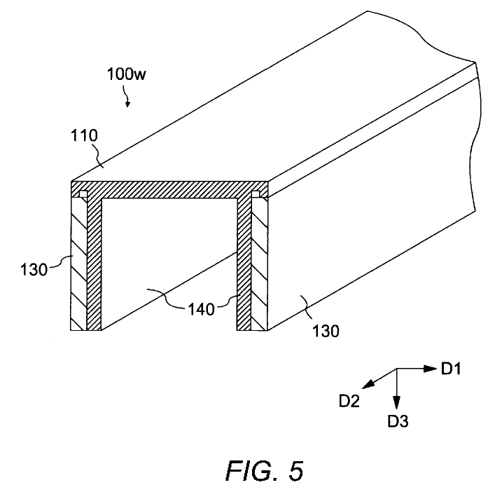

FIG. 5 is an exploded perspective view showing a configuration of a white key according to one embodiment of this disclosure. The perspective view shown in FIG. 5 is a perspective view of the white key 100w cut at the position indicated by the dashed line in FIG. 4. As shown in FIG. 5, the white key 100w has key side portions 140 in addition to the members described above. The white key 100whas a hollow structure. In other words, the key side portions 140 form a substantially U shape (more precisely, an inverted U shape). The key side plates 130 are attached to the outer side surfaces of the key side portions 140.

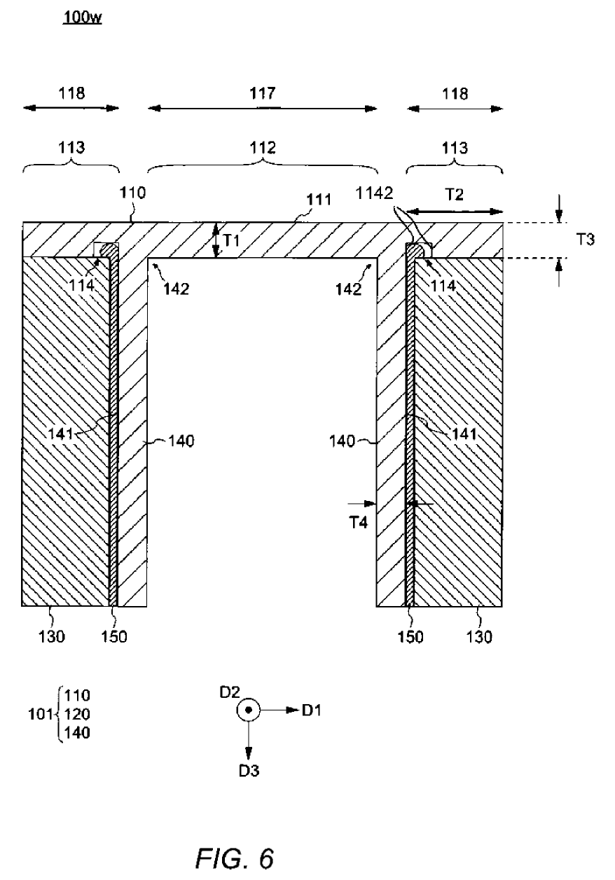

FIG. 6 is a cross-sectional view of the white key according to one embodiment of this disclosure. The cross-sectional view of FIG. 6 is an enlarged view of the cross section portion of the perspective view of FIG. 5. As shown in FIG. 6, the key top portion 110 has a first surface 111. The first surface 111 is a surface that is visible from the player and the surface configured to receive the player's operation(s). While the details will be described further below, the key top portion 110 is divided into two regions (second portion 112 and one or two protrusions 113). The key side portions 140 each have a second surface 141. The second surface 141 is a surface on the opposite side of the surfaces of the pair of key side portions 140 facing each other, and extends in a D3 direction intersecting the first surface 111. The second surface 141 is a surface to which the key side plate 130 is attached. The D3 direction can be referred to as the "first direction."

The pair of key side portions 140 are disposed facing each other and extend in the D3 direction substantially parallel to each other. The key side portion 140 can be referred to as the "first portion." The pair of key side portions 140 are connected to the key top portion 110 at the respective first ends 142 thereof. The key top portion 110 includes the second portion 112 and the protrusions 113. The second portion 112 is provided between the pair of key side portions 140 in the D1 direction and connects the pair of key side portions 140 at the respective first ends 142 thereof. The protrusions 113 are provided on the outer sides of the pair of key side portions 140 in the D1 direction, and protrude from the respective first ends 142 outward of the pair of key side portions 140. As shown in FIG. 5, the second portion 112 and the protrusions 113 are formed on a same plane extending in the D1 and D2 directions. The first surface 111 includes the second portion 112 and the protrusions 113. Of the white key 100w, the key top portion 110, the key front portion 120, and the key side portions 140 can be referred to as a key body 101 (or "first member"). The key body 101 is a resin member and is integrally formed.

The thickness T1 of the second portion 112 in the D3 direction is less than the length T2 of the protrusion 113 in the D1 direction. The key top portion 110 can be divided into a first region 117 and a second region 118. The first region 117 is the region between the pair of key side portions 140. The second region 118 is a region on the outer side of the first region 117. In this embodiment, the second region 118 includes two regions on the outer sides of the first region 117. The key top portion 110 in the first region 117 and the key top portion 110 in the second regions 118 are contiguously formed. In the example of FIG. 6, the top surface of the key top portion 110 in the first region 117 and the top surface of the key top portion 110 in the second regions 118 are on the same plane.

Referring to FIGS. 5 and 6, the protrusions 113 (the key top portion 110 in the second regions 118) protrude from the sides of the key top portion 110 in the first region 117 across the D2 direction (front-rear direction).

It can be said that the thickness T1 of the key top portion 110 in the first region 117 in the D3 direction is less than the width T2 of the key top portion 110 in the second regions 118 in the D1 direction. In addition, in the D3 direction, the thickness T1 of the key top portion 110 in the first region 117 is substantially the same as the thickness T3 of the key top portion 110 in the second regions 118. The thickness T1 of the key top portion 110 in the first region 117 in the D3 direction is greater than the width T4 of the key side portion 140 in the D1 direction. “Substantially the same” means that the size of one is within the range of ±10 % of the size of the other. The D1 direction can be referred to as the "third direction."

The key side plate 130 is attached to the second surface 141 via an adhesive 150. In the present embodiment, the adhesive 150 is provided on the entire area of the second surface 141, and the key side plate 130 is bonded to the second surface 141 by the adhesive 150. The key side plate 130 can be referred to as a "second member" or a "plate-like member." In other words, the key side plate 130 is disposed such that at least a portion of the upper end surface of the key side plate 130 faces the lower surface of the key top portion 110 in the second region 118.

A recess 114 is provided in a portion of the protrusion 113 on the D3 direction side. In other words, the recess 114 is provided on the surface of the protrusion 113 facing the key side plate 130. The recess 114 has a shape that is recessed in the direction opposite to the D3 direction. In other words, the recess 114 is recessed in the direction opposite to the direction in which the key side portion 140 extends from the first end 142. In other words, the side walls 1142 of the recess 114 extend in the same direction as a side wall (second surface 141) of the key side portion 140. In other words, the recess 114 that is recessed in the direction opposite to the D3 direction is provided on the key body 101 (first member) at a location adjacent to a region at which the key side plate 130 (second member) is attached to the second surface 141. In other words, the key top portion 110 in the second region 118 has the recess 114 on the lower surface of the key top portion 110. A part of the side walls 1142 of the recess 114 is contiguous with the second surface 141. That is, as viewed from the direction opposite to the D3 direction, the second surface 141 and the part of the side walls 1142 of the recess 114 are provided at the same location. The direction opposite to the D3 direction can be referred to as the "second direction." The recess 114 can be referred to as a groove.

The recess 114 functions as a relief space (sometimes referred to as "collection portion" or "buffer") for the excess adhesive 150 when attaching the key side plate 130 to the second surface 141 using the adhesive 150. In a state immediately after the key side plate 130 is attached, the adhesive 150 is preferably in a state of being fully contained between the key side plate 130 and the second surface 141, that is, a state in which no part of the adhesive 150 has leaked out from the region between the key side plate 130 and the second surface 141. If the excess adhesive 150 leaks out of the region between the key side plate 130 and the second surface 141, it becomes necessary to wipe off the leaked adhesive 150, which decreases work efficiency. In the present embodiment, since the recess 114 functions as a relief space for the excess adhesive 150, it is possible to prevent the occurrence of such a problem.

Furthermore, since the side walls 1142 of the recesses 114 extend in the same (or opposite) direction as the second surface 141, the metal mold can be pulled out in the D3 direction and the opposite direction when molding the key body 101. As a result, the size of the metal mold can be reduced, and the number of the key bodies 101 that can be produced in one molding step can be increased.

### 1-4. First Modified Example

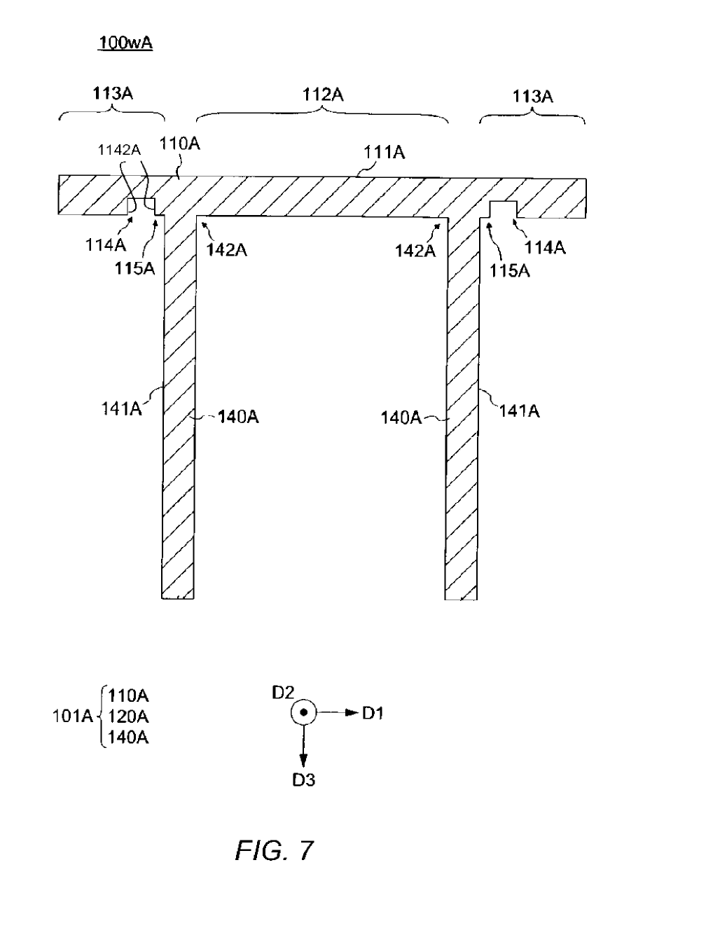

A modified example of the first embodiment will be described with reference to FIG. 7. FIG. 7 is a cross-sectional view of a white key according to a modified example of one embodiment of this disclosure. For the sake of convenience, in FIG. 7, members corresponding to the key side plates 130 and the adhesive 150 of FIG. 6 are omitted. A key body 101A shown in FIG. 7 is similar to the key body 101 shown in FIG. 6, but is different in the locations where recesses 114A are provided. In the following description, explanations of configurations that are the same as the first embodiment are omitted, and differences from the first embodiment will be mainly explained. In the following description, when describing configurations that are similar to those of the first embodiment, FIGS. 1 to 6 will be referenced, and the alphabet "A" will be added after the reference symbols indicated in these figures.

As shown in FIG. 7, the recesses 114A are provided on the outer sides of key side portions 140A. As a result, a stepped portion 115A is formed between the key side portion 140A and the recess 114A. When a white key 100wA is viewed from the direction opposite to the D3 direction, second surfaces 141A and side walls 1142A of the recesses 114A are provided at different locations. In other words, the side walls 1142A of the recesses 114A are located on the outer sides of the region sandwiched by the extensions of the pair of second surfaces 141A. Even with this configuration, the same effect as the first embodiment can be obtained.

### 1-5. Second Modified Example 2

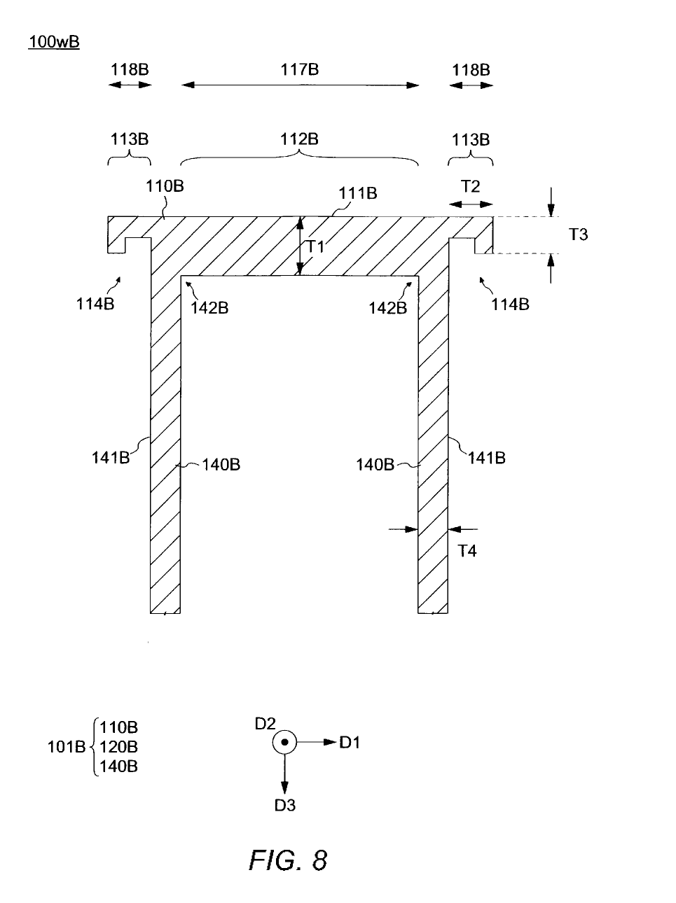

A modified example of the first embodiment will be described with reference to FIG. 8. FIG. 8 is a cross-sectional view of a white key according to a modified example of one embodiment of this disclosure. For the sake of convenience, in FIG. 8, members corresponding to the key side plates 130 and the adhesive 150 of FIG. 6 are omitted. A key body 101B shown in FIG. 7 is similar to the key body 101 shown in FIG. 6, but is different in the thickness of a second portion 112B and the length of protrusions 113B. In the following description, explanations of configurations that are the same as the first embodiment are omitted, and differences from the first embodiment will be mainly explained. In the following description, when describing configurations that are similar to those of the first embodiment, FIGS. 1 to 6 will be referenced, and the alphabet "B" will be added after the reference symbols indicated in these figures.

As shown in FIG. 8, the key body 101B (first member) includes a key top portion 110B and a pair of key side portions 140B. The key top portion 110B is divided into a first region 117B and second regions 118B. The first region 117B is the region between the pair of key side portions 140B. The second regions 118B are regions on the outer sides of the first region 117B. The D1 direction can be referred to as the "third direction."

As shown in FIG. 8, the thickness T1 of the second portion 112B in the D3 direction is greater than the length T2 of the protrusion 113B in the D1 direction. In other words, the thickness T1 of the key top portion 110B in the first region 117B in the D3 direction is greater than the width T2 of the key top portion 110B in the second region 118B in the D1 direction. In addition, in the D3 direction, the thickness T1 of the key top portion 110B in the first region 117B is greater than the thickness T3 of the key top portion 110B in the second region 118B. The thickness T1 of the key top portion 110B in the first region 117B in the D3 direction is greater than the width T4 of the key side portion 140B in the D1 direction.

With this configuration, it is possible to reduce the thickness of the key side plate 130B in the D1 direction while maintaining the strength of the key top portion 110B. When molding the key top portion 110B from resin, if the thickness of the key top portion 110B is small, there are cases in which recesses called "sink marks" are formed on a first surface 111B at locations corresponding to the key side portions 140B. However, the occurrence of "sink marks" can be prevented if the key top portion 110B is sufficiently thick, as described above. In addition, as a result of the length of the protrusions 113B in the D1 direction being short, the material cost of the key side plates 130B can be suppressed.

### 2. Second Embodiment

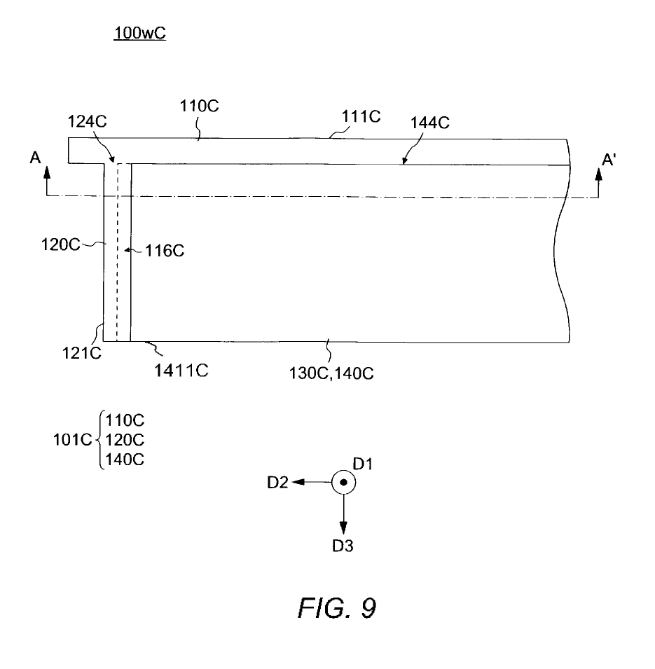

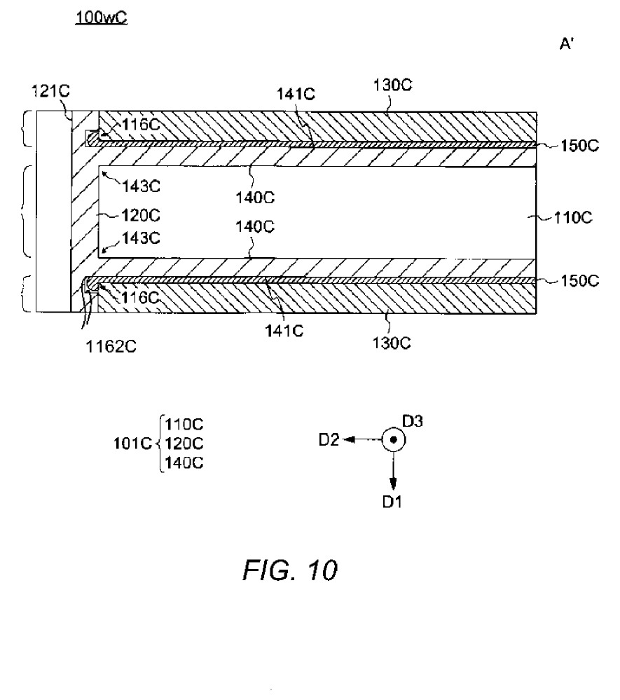

A white key 100wC according to a second embodiment will be described with reference to FIG. 9. FIG. 9 is a side view of a white key according to one embodiment of this disclosure. The side view shown in FIG. 9 is a side view of the white keys 100w shown in FIG. 4 as viewed from the direction opposite to the D1 direction. FIG. 10 is a cross-sectional view of a white key according to one embodiment of this disclosure. Specifically, FIG. 10 is a cross-section diagram along the A-A' line in FIG. 9. In the following description, when describing configurations that are similar to those of the first embodiment, FIGS. 1 to 6 will be referenced, and the alphabet "C" will be added after the reference symbols indicated in these figures.

### 2-1. Configuration of white key 100w

As shown in FIGS. 9 and 10, a key front portion 120C has a first surface 121C. The first surface 121C is a surface that is visible from the player. Key side portions 140C each have a second surface 141C. The second surface 141C extends in the D2 direction intersecting the first surface 121C. While the details will be described further below, the second surface 141C is the surface to which the key side plate 130C is attached.

As shown in FIG. 10, the pair of key side portions 140C is disposed facing each other and extends in the D3 direction substantially parallel to each other. The key side portions 140C can be referred to as the "first portion." The pair of key side portions 140C are connected to the key front portion 120C at the respective first ends 143C thereof. As shown in FIG. 9, an upper end portion 144C of each of the pair of key side portions 140C and an upper end portion 124C of the key front portion 120C are connected by a key top portion 110C. The key top portion 110C can be referred to as the "third portion." As shown in FIG. 10, the key front portion 120C includes a second portion 122C and protrusions 123C. The second portion 122C is provided between the pair of key side portions 140C in the D1 direction and connects the pair of key side portions 140C at the respective first ends 143C thereof. The protrusions 123C are provided on the outer sides of the region sandwiched by the pair of key side portions 140C in the D1 direction, and protrude from the respective first ends 143C (front end portions) of the pair of key side portions 140C outward of the pair of key side portions 140C. As shown in FIG. 10, the second portion 122C and the protrusions 123C are formed on the same plane extending in the D1 and D3 directions. The first surface 121C includes the second portion 122C and the protrusions 123C. Of the white key 100wC, the key top portion 110C, the key front portion 120C, and the key side portions 140C can be referred to as a key body 101C (or "first member"). The key body 101C is a resin member and is integrally formed.

The key side plate 130C is attached to the second surface 141C via an adhesive 150C. In the present embodiment, the adhesive 150C is provided on the entire area of the second surface 141C, and the key side plate 130C is bonded to the second surface 141C by the adhesive 150C. The key side plate 130C can be referred to as a "second member" or a "plate-like member." In other words, the key side plate 130C is disposed such that at least a portion of the front end surface of the key side plate 130C faces a recess 116C, described further below.

The recess 116C is provided in a portion of the protrusion 123C on the side opposite to the D2 direction In other words, the recess 116C is provided on the surface of the protrusion 123C facing the key side plate 130C. The recess 116C has a shape that is recessed in the D2 direction. In other words, the recess 116C is recessed in the direction opposite to the direction in which the key side portion 140C extends from the first end 143C. In other words, the side walls of the recess 116C extend in the same direction as a side wall (second surface 141C) of the key side portion 140C. In other words, the recess 116C that is recessed in the D2 direction is provided on the key body 101C (first member) at a location adjacent to a region at which the key side plate 130C (second member) is attached to the second surface 141C. A part of the side walls 1162C of the recess 116C is contiguous with the second surface 141C. That is, as viewed from the D2 direction, the second surface 141C and the part of the side walls 1162C of the recess 116C are provided at the same location. As shown in FIG. 9, the recess 116C extends from the key top portion 110C to the end 1411C of the second surface 141C in the D3 direction. In other words, the recess 116C provided to the protrusion 123C extends in the D3 direction (up-down direction) on the surface facing the key side plate 130C. The D2 direction can be referred to as the "fourth direction."

The recess 116C functions as a relief space for the excess adhesive 150C when attaching the key side plate 130C to the second surface 141C using the adhesive 150C, in the same manner as the recess 114 of the first embodiment.

Furthermore, since the side walls 1162C of the recess 116C extend in the same (or opposite) direction as the second surface 141C, the metal mold can be pulled out in the D2 direction and the opposite direction when molding the key body 101C. As a result, the size of the metal mold can be reduced, and the number of the key bodies 101C that can be produced in one molding step can be increased.

### 2-2. Modified Example

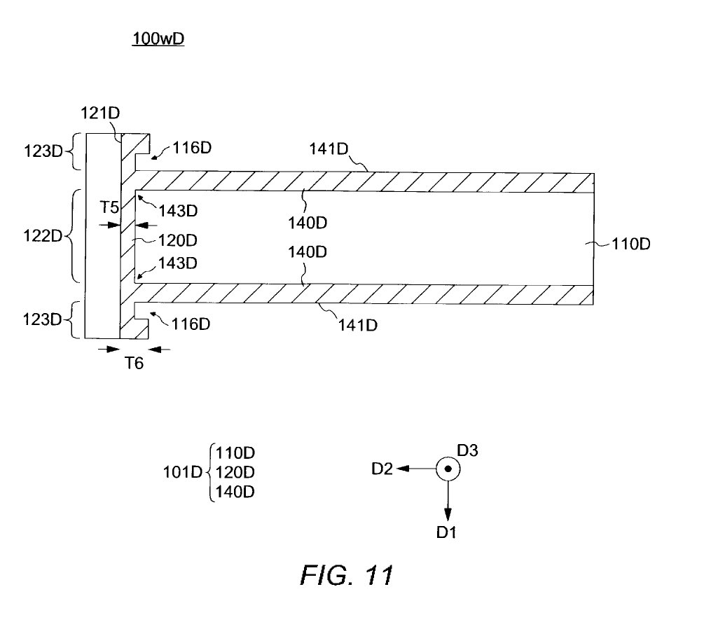

A modified example of the second embodiment will be described with reference to FIG. 11. FIG. 11 is a cross-sectional view of a white key according to a modified example of one embodiment of this disclosure. For the sake of convenience, in FIG. 11, members corresponding to the key side plates 130C and the adhesive 150C of FIG. 10 are omitted. A key body 101D shown in FIG. 11 is similar to the key body 101C shown in FIG. 10, but is different in the relationship between the thickness of a second portion 122D and the thickness of protrusions 123D. In the following description, explanations of configurations that are the same as the second embodiment are omitted, and differences from the second embodiment will be mainly explained. In the following description, when describing configurations that are similar to those of the first embodiment, FIGS. 1 to 6 will be referenced, and the alphabet "D" will be added after the reference symbols indicated in these figures.

In the D2 direction, the thickness T5 of the second portion 122D is different from the thickness T6 of the protrusion 123D. In the example of FIG. 11, in the D2 direction, the thickness T5 of the second portion 122D is less than the thickness T6 of the protrusion 123D. When molding the key body 101D from resin, if the thickness of the key front portion 120D in the D2 direction is small, there are cases in which recesses called "sink marks" are formed on a key top portion 110D at locations corresponding to the key front portion 120D. However, the occurrence of "sink marks" can be prevented if the key front portion 120D is sufficiently thin, as described above.

### 3. Third Embodiment

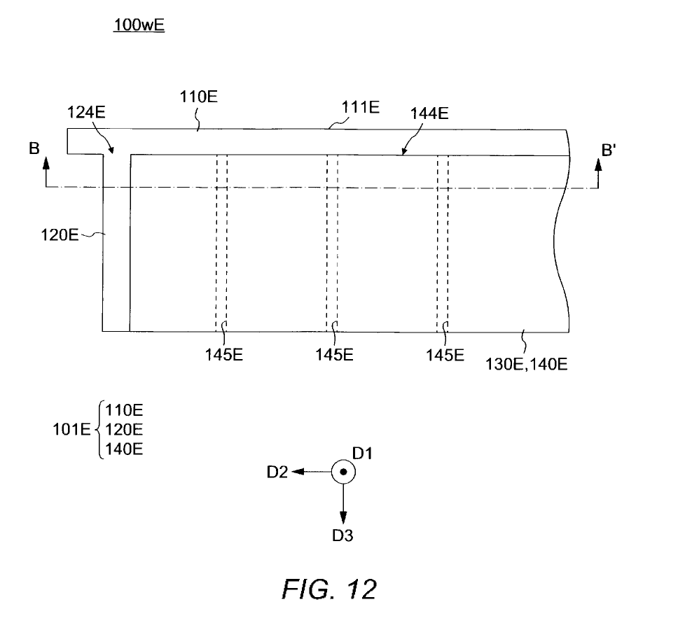

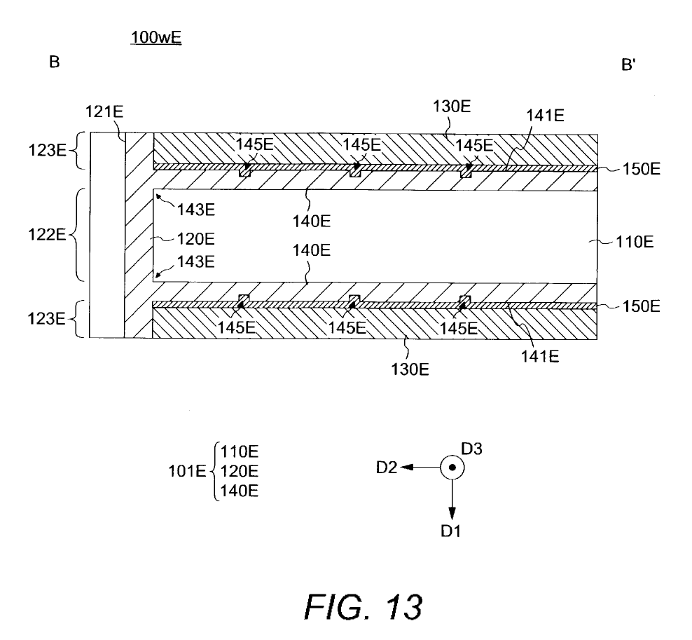

A white key 100wE according to a third embodiment will be described with reference to FIG. 12. FIG. 12 is a side view of a white key according to one embodiment of this disclosure. The side view shown in FIG. 12 is a side view of the white key 100w shown in FIG. 4 as viewed from the direction opposite to the D1 direction, similar to FIG. 9. FIG. 13 is a cross-sectional view of a white key according to one embodiment of this disclosure. Specifically, FIG. 13 is a cross-section diagram along the B-B' line in FIG. 12. In the following description, when describing configurations that are similar to those of the first embodiment, FIGS. 1 to 6 will be referenced, and the alphabet "E" will be added after the reference symbols indicated in these figures.

### 3-1. Configuration of white key 100w

As shown in FIGS. 12 and 13, a key body 101E includes a pair of key side portions 140E disposed facing each other, a key front portion 120E, and a key top portion 110E. A second portion 122E of the key front portion 120E is provided between the pair of key side portions 140E. The second portion 122E connects the pair of key side portions 140E at the respective upper ends thereof. The key top portion 110E connects the respective upper ends of the pair of key side portions 140 and the upper end of the second portion 122E. The key top portion 110E has a first surface 111E that receives the player's operation(s).

As shown in FIG. 13, a second surface 141E of the key side portion 140E is provided with recesses 145E. As shown in FIG. 12, the recesses 145E are provided from the key top portion 110E to the lower end of the key side portion 140E. In other words, the lower ends of the recesses 145E are open. As shown in FIG. 13, since a key side plate 130E is provided in front of the recesses 145E, the recesses 145E are shown using dotted lines in FIG. 12. That is, the recesses 145E are provided from the key top portion 110E (third portion) to the end of the key side portions 140E (first portion) on the opposite side of the key top portion 110E. The width of the recesses 145E in the D2 direction is approximately constant from the vicinity of the key top portion 110E to the lower end of the key side portion 140E. As shown in FIG. 13, a plurality of the recesses 145E are provided side by side in the D2 direction. The recesses 145E are recessed in a direction intersecting the second surface 141E (D1 direction or the direction opposite to the D1 direction).

The recesses 145E function as relief spaces for excess adhesive 150E when attaching the key side plate 130E to the second surface 141E using the adhesive 150E, in the same manner as the recess 114 of the first embodiment.

Furthermore, since the recesses 145E are provided from the key top portion 110E to the lower end of the key side portion 140E, the metal mold can be pulled out in the D3 direction and the opposite direction when molding the key body 101E. As a result, the size of the metal mold can be reduced, and the number of the key bodies 101E that can be produced in one molding step can be increased.

### 3-2. Modified Example

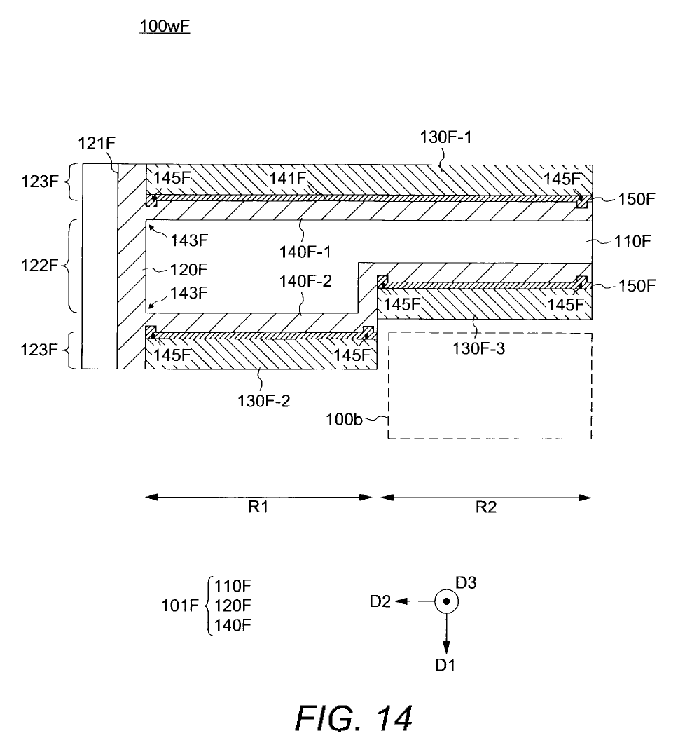

A modified example of the third embodiment will be described with reference to FIG. 14. FIG. 14 is a cross-sectional view of a white key according to a modified example of one embodiment of this disclosure. A key body 101F shown in FIG. 14 is similar to the key body 101E shown in FIG. 13, but is different in the shape in plan view. In the following description, explanations of configurations that are the same as the third embodiment are omitted, and differences from the third embodiment will be mainly explained. In the following description, when describing configurations that are similar to those of the first embodiment, FIGS. 1 to 6 will be referenced, and the alphabet "F" will be added after the reference symbols indicated in these figures.

As shown in FIG. 14, the width of a white key 100wF in the D1 direction is different depending on the location in the D2 direction. Specifically, the width of the white key 100wF in the D1 direction in a first region R1 close to a key front portion 120F is greater than the width of the white key 100wF in the D1 direction in a second region R2 far from the key front portion 120F. For example, the second region R2 is a region in which the white key 100wF and a black key 100bF are adjacent to each other.

In such a configuration, the shape of each of opposing key side portions 140F-1, 140F-2 is different. The key side portion 140F-1 has a shape extending linearly in the D2 direction. On the other hand, the key side portion 140F-2 is bent in the direction opposite to the D1 direction in the vicinity of the boundary between the first region R1 and the second region R2. Accordingly, three members are required, namely key side plates 130F-1, 130F-2, and 130F-3. In this case, a recess 145F is provided for each of the key side plates 130F-1, 130F-2, and 130F-3 at the respective ends thereof in the D2 direction and the direction opposite to the D2 direction. By arranging the recesses 145F in this manner, it is possible to prevent the adhesive 150F from leaking to the outside while spreading the adhesive 150F over as wide a range as possible. An additional recess 145F can be provided between two of the recesses 145F in the key side plates 130F-1, 130F-2, and 130F-3.

4. Modified Example

In the embodiments described above, for example, as shown in FIG. 6, a configuration is shown in which the key top portion 110, the key front portion 120, and the key side portions 140 are integrally formed, but this disclosure is not limited to this configuration. The foregoing members can be separately formed and fixed to each other using an adhesive, or the like. In addition, a configuration is shown in which the second portion 112 and the protrusions 113 are formed on the same plane extending in the D1 and D2 directions, but this disclosure is not limited to this configuration. For example, the protrusions 113 and the second portion 112 can be provided at different locations in the D3 direction. In this case, a stepped portion can be formed between the second portion 112 and each of the protrusions 113.

Similarly, a configuration is shown in which the key body 101 includes the key top portion 110, the key front portion 120, and the key side portions 140, but this disclosure is not limited to this configuration. The key body 101 can be configured to include at least the key top portion 110 and the pair of key side portions 140.

Similarly, in the example of FIG. 6, a configuration is shown in which the key side plate 130 is attached to the entire area of the second surface 141, but this disclosure is not limited to this configuration. The key side plate 130 needs only to be attached along at least a portion of the pair of key side portions 140, and, for example, there can be regions on a portion of the key side portion 140 to which the key side plate 130 is not provided. In addition, in the example of FIG. 6, a configuration is shown in which one key side plate 130 is attached to one second surface 141, but this disclosure is not limited to this configuration. A plurality of the key side plates 130 can be attached to one second surface 141. In addition, in the example of FIG. 6, a configuration is shown in which, when viewed from the direction opposite to the D3 direction, the part of the side walls 1142 of the recess 114 are entirely provided on the extension of the second surface 141, but this disclosure is not limited to this configuration. At least the part of the side walls 1142 of the recess 114 can be partially provided at a location different from the extension of the second surface 141.

Similarly, in the example of FIG. 6, a configuration is shown in which the second surface 141 is provided to both of the pair of key side portions 140, but it is sufficient if the second surface 141 is provided on at least one of the pair of key side portions 140.

In the second embodiment described above, a configuration is shown in which the recess 116C extends in the D3 direction (up-down direction), as shown in FIGS. 9 and 10, but this disclosure is not limited to this configuration. The recess 116C can extend in a direction including the D3 direction. For example, the recess 116C can extend in a direction that includes a component of the D3 direction and a component of the D1 direction and/or D2 direction.

In the modified example of the second embodiment described above, a configuration is shown in which the thickness T5 of the second portion 122D in the D2 direction is less than the thickness T6 of the protrusion 123D, as shown in FIG. 11, but this disclosure is not limited to this configuration. The thickness T5 of the second portion 122D can be greater than the thickness T6 of the protrusions 123D in the D2 direction.

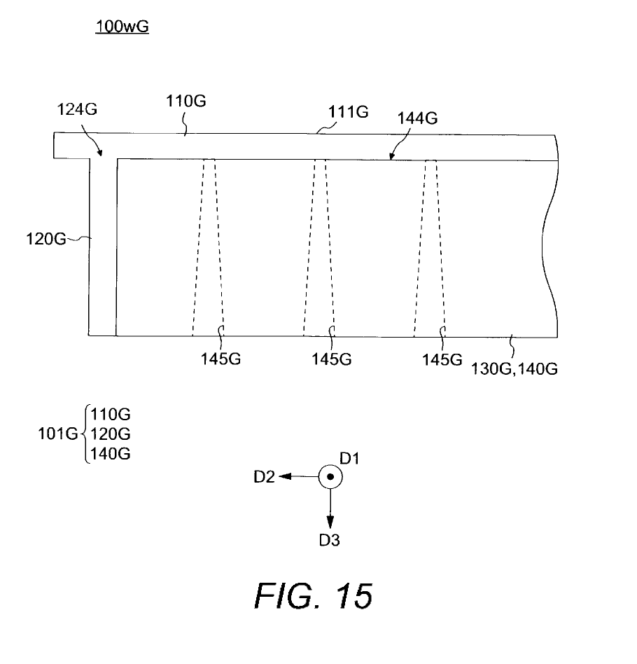

In the third embodiment described above, a configuration is shown in which the width of the recesses 145E in the D2 direction is approximately constant from the vicinity of the key top portion 110E to the lower ends of the key side portions 140E, as shown in FIG. 12, but this disclosure is not limited to this configuration. For example, the width of recesses 145G in the D2 direction can be configured to gradually increase from the vicinity of a key top portion 110G toward the lower ends of key side portions 140G, as shown in FIG. 15. According to such a configuration, the metal mold can be pulled out in the D3 direction and the opposite direction when molding the key body 101G, in the same manner as in the third embodiment.

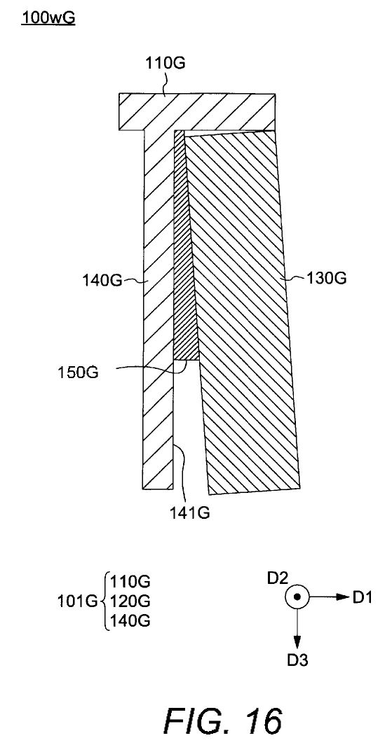

Furthermore, as shown in FIG. 16, when attaching a key side plate 130G to the key side portion 140G, there can be cases in which the key side plate 130G is attached onto the key side portion 140G gradually from the upper end of the key side portion 140G downward while rotating the key side plate 130G counterclockwise in FIG. 16. In this case, a large amount of excess adhesive 150G gathers on the lower side of the key side portion 140G. Even in such a case, since the recesses 145G shown in FIG. 15 can accommodate a large amount of the excess adhesive 150G toward the bottom, it is possible to prevent the excess adhesive 150G from leaking to the outside.

In the third embodiment, a configuration is shown in which the lower ends of the recesses 145E are open as shown in FIG. 12, but this disclosure is not limited to this configuration. For example, the upper ends of the recesses 145E can be open.

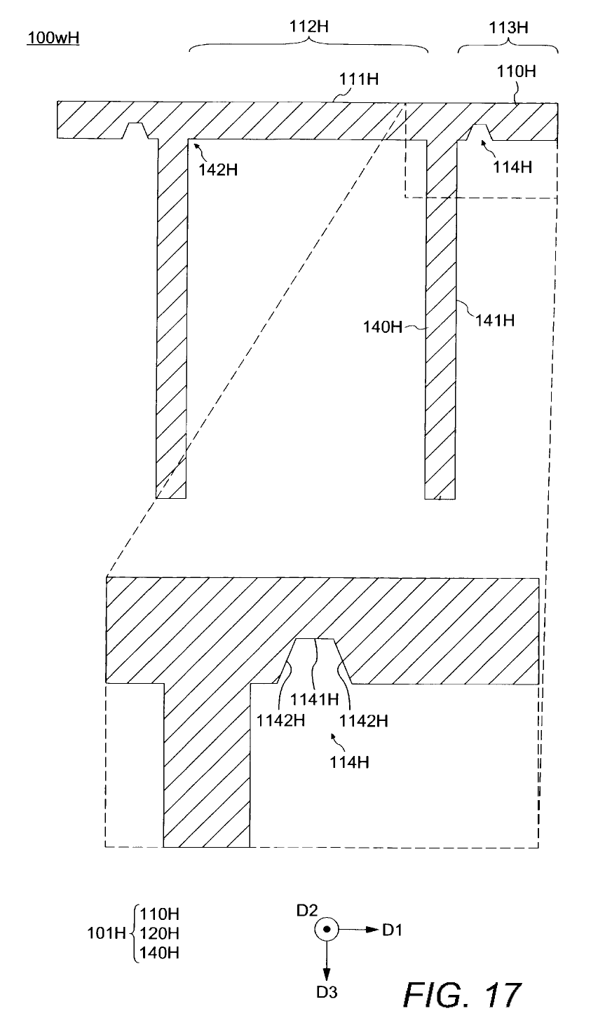

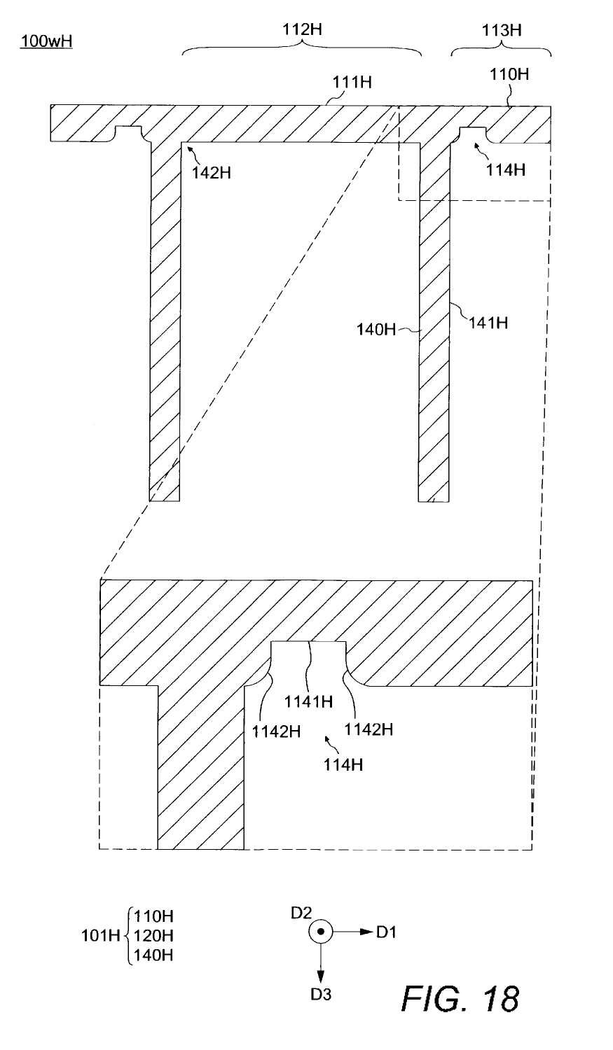

In the embodiments described above, a configuration is shown in which, for example, the side walls of the recesses 114, 116C, and 145E are perpendicular to the bottom surface of the recesses, but this disclosure is not limited to this configuration. For example, as shown in FIG. 17, a recess 114H can include a bottom portion 1141H and side walls 1142H, and at least two or more the side walls 1142H can be inclined. In other words, the at least two or more side walls 1142H are inclined such that the width of the recess 114H expands from the bottom portion 1141H toward the end on the opposite side of the bottom portion 1141H. As shown in FIG. 18, the shape of the side walls 1142H can be curved.

As a result of the side walls 1142H having the shape described above, the adhesive 150 in the vicinity thereof can easily enter the recess 114H, thereby preventing the excess adhesive 150H from leaking to the outside.

In FIGS. 17 and 18, a configuration is shown in which the bottom portion 1141H is flat, but this disclosure is not limited to this configuration. For example, the bottom portion 1141H can have a curved shape. Specifically, the bottom portion 1141H has a shape that forms an arc upward.

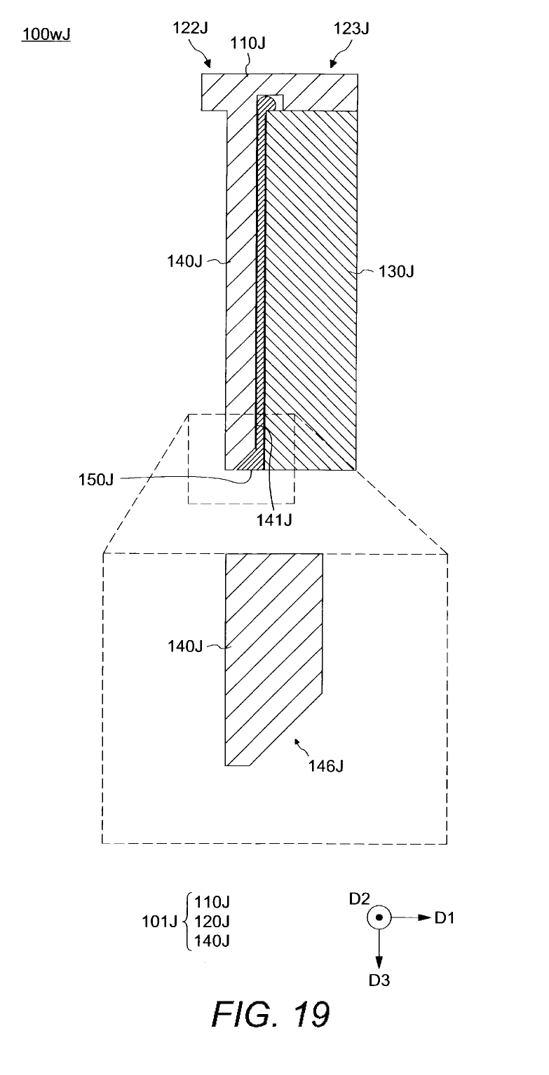

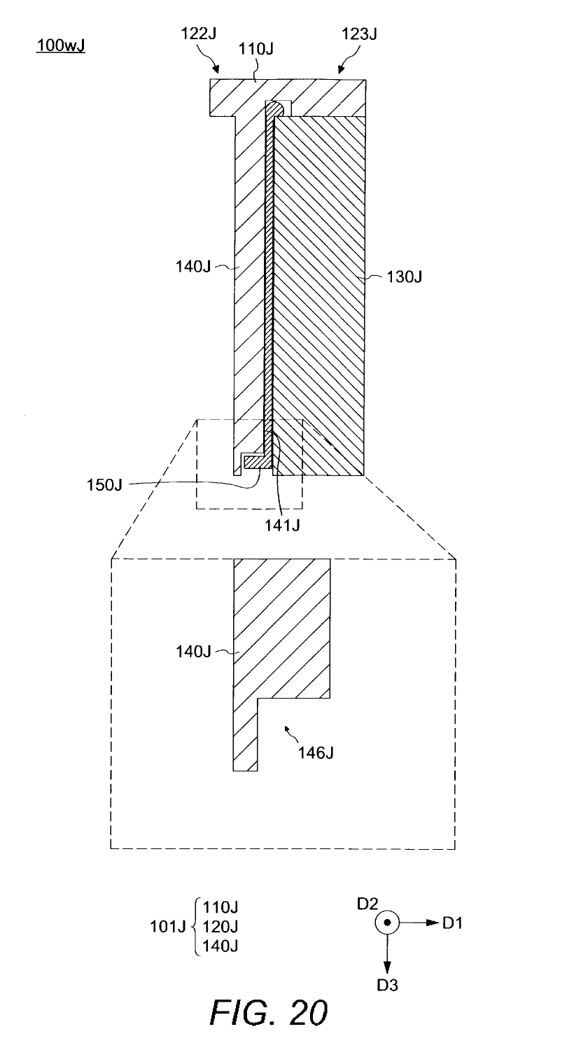

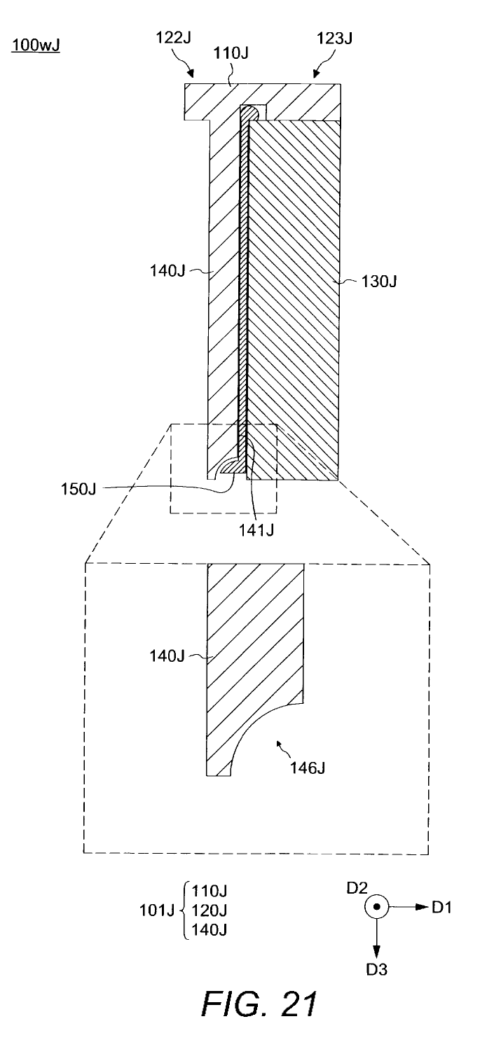

In addition, in the embodiments described above, a configuration is shown in which, for example, the ends of the key side portions 140 in the D3 direction are shaped like a partial rectangle, but this disclosure is not limited to this configuration. For example, as shown in FIG. 19, a notch 146J can be formed at the end of a key side portion 140J in the D3 direction. In the case of FIG. 19, a configuration is shown in which a slope is formed by the notch 146J, but a stepped portion can be formed by the notch 146J as shown in FIG. 20, or a curved surface can be formed by the notch 146J as shown in FIG. 21. In other words, the end of the second surface 141J in the D3 direction is bent in the direction opposite to the D1 direction intersecting the second surface 141J. In other words, the surface of the key side portion 140J (first portion) to which a key side plate 130J is attached is bent in a direction away from the key side plate 130J at the lower end on the side farther from a second portion 122J. When this configuration is applied to FIG. 10, the surface of the key side portion 140C (first portion) to which the key side plate 130C is attached is bent in a direction away from the key side plate 130C at the lower end on the side farther from a key top portion 110C (third portion).

As shown in FIGS. 19 to 21, as a result of the notch 146J being provided at the lower end of the key side portion 140J, it is possible to prevent the excess adhesive 150J from leaking to the outside.

In the embodiments described above, a configuration is shown in which the key top portion 110 and the key front portion 120 are integrally formed as the key body 101, but this disclosure is not limited to this configuration. For example, members corresponding to the key top portion 110 and/or the key front portion 120 can be separately formed and bonded to the key body. In this case, a recess or a groove that functions as a relief space for the above-mentioned adhesive can be provided in a member corresponding to the separately-formed key top portion 110 and/or key front portion 120, or provided in the key body, which is the base to which these members are bonded. In this case, the key body can be a wooden member or a resin member.

In the embodiments described above, the white keys 100w are mainly described, but the above-mentioned embodiments can also be applied to the black keys 100b.

This disclosure is not limited to the embodiments described above, and can be modified within the scope of the spirit of this disclosure. The embodiments described above as embodiments of this disclosure can be implemented in any combination as long as the embodiments are not mutually contradictory.

Constituent features that specify this disclosure

The following constituent features can be set forth in the claims based on the embodiments described above.

### Constituent feature 1

A key for a keyboard device comprising: a key body provided with a pair of first portions arranged facing each other, a second portion that is provided between the pair of first portions and connecting the pair of first portions to each other at respective first ends thereof, and a protrusion that protrudes from each of the first ends of the pair of first portions outward of the pair of first portions; and

one or more plate-like members that are attached via an adhesive along at least a portion of the pair of first portions of the key body, wherein

the protrusion has a recess on a surface facing the plate-like member.

### Constituent feature 2

The key for a keyboard device according to constituent feature 1, wherein a portion of the side walls of the recess is located on an extension of a surface of the first portion to which the plate-like member is attached.

### Constituent feature 3

The key for a keyboard device according to constituent feature 1, the side walls of the recess are located on the outer side of the pair of first portions than an extension of a surface of the first portion to which the plate-like member is attached.

### Constituent feature 4

The key for a keyboard device according to constituent feature 1, wherein the thickness of the second portion is different from the thickness of the protrusion.

### Constituent feature 5

The key for a keyboard device according to constituent feature 1, wherein the thickness of the second portion is greater than the length by which the protrusion protrudes from the first portion.

### Constituent feature 6

The key for a keyboard device according to constituent feature 1, further comprising a third portion that connects the first end of each of the pair of first portions and an end of the second portion, and that has a first surface that receives a player's operations.

### Constituent feature 7

A key for a keyboard device comprising: a key body provided with a pair of first portions arranged facing each other, a second portion that is provided between the pair of first portions and connecting the pair of first portions to each other at respective first ends thereof, and a third portion provided with a first surface that connects respective second ends of the pair of first portions and an end of the second portion and receives a player's operations; and

one or more plate-like members that are attached via an adhesive along at least a portion of the pair of first portions of the key body, wherein

the first portion has, on a surface facing the plate-like member, a recess provided from the third portion to an end of the first portion on the opposite side of the third portion.

### Constituent feature 8

The key for a keyboard device according to constituent feature 7, wherein a plurality of the recesses are provided in the pair of first portions.

Constituent feature 9

The key according to any one of constituent features 1 to 8, wherein the recess is provided with a bottom portion and side walls, and

an end of the side wall on the opposite side of the bottom portion is inclined or curved such that the width of the recess expands.

### Constituent feature 10

The key according to any one of constituent features 1 to 6, wherein the surface of the first portion to which the plate-like member is attached is bent in a direction away from the plate-like member at a second end on the side farther from the second portion.

### Constituent feature 11

The key according to constituent feature 7 or 8, wherein the surface of the first portion to which the plate-like member is attached is bent in a direction away from the plate-like member at a third end on the side farther from the third portion.

### Constituent feature 12

A key for a keyboard device according to one embodiment of this disclosure includes a key body and one or more plate-like members. The key body includes a pair of side portions and protrusions that protrude from front end portions of the side portions toward sides of the key body, and the key body has a longitudinal dimension in a front-rear direction. The one or more plate-like members are each attached via an adhesive to at least a portion of the pair of side portions of the key body. The at least one of the one or more plate-like members is arranged such that at least a portion of a front end surface of the at least one of the one or more plate-like members faces one of the protrusions. The one of the protrusions has a recess that extends in a direction including at least an up-down direction on a surface that faces the at least one of the one or more plate-like members.

### Constituent feature 13

A key for a keyboard device according to one embodiment of this disclosure includes a key body and one or more plate-like members. The key body includes a pair of side portions, and the key body has a longitudinal dimension in the front-rear direction. The one or more plate-like members are each attached via an adhesive to at least a portion of the pair of side portions of the key body. The at least one of the side portions has a recess extending in a direction including at least an up-down direction on a surface facing one of the one or more plate-like members, and the recess is open at least one of both of an upper end or a lower end.

### Effects of This Disclosure

According to one embodiment of this disclosure, it is possible to provide keys that can simplify the manufacturing equipment and improve productivity.

What is claimed is:

1. A key for a keyboard device, the key comprising:
a first member including a first surface configured to receive a player's operation, and a second surface that extends in a first direction intersecting the first surface; and
a second member attached to the second surface via an adhesive,
the first member further including a recess that is recessed in a second direction opposite to the first direction, the recess being arranged adjacent to a region where the second member is attached to the second surface.

2. The key according to claim 1, wherein
as viewed in the second direction, the second surface and a part of a side wall of the recess are arranged at a same location.

3. The key according to claim 1, wherein
as viewed in the second direction, the second surface and a side wall of the recess are arranged at different locations.

4. The key according to claim 1, wherein
the first member further includes
a key top portion having the first surface, and
a pair of key side portions that extend from the key top portion in the first direction and are arranged side by side in a third direction intersecting the second surface,
the second surface is disposed on at least one of the pair of key side portions,
the key top portion is divided into a first region between the pair of key side portions and a second region on an outer side of the first region, and
a thickness of the key top portion in the first region in the first direction is greater than a width of the key top portion in the second region in the third direction.

5. A key for a keyboard device, the key comprising:
a first member including a first surface configured to receive a player's operation, and a second surface that extends in a first direction intersecting the first surface; and
a second member attached to the second surface via an adhesive,
the first member further including a recess that extends to an end of the second surface in the first direction, the recess being arranged adjacent to a region where the second member is attached to the second surface.

6. The key according to claim 5, wherein
the first surface has a longitudinal dimension in a fourth direction, and
the recess is recessed in the fourth direction.

7. The key according to claim 5, wherein
the recess is recessed in a third direction intersecting the second surface.

8. The key according to claim 7, wherein
the first surface has a longitudinal dimension in a fourth direction, and
a plurality of recesses including the recess are arranged side by side in the fourth direction.

9. The key according to claim 1, wherein
the recess includes a bottom portion and a side wall, and
the side wall is inclined or curved such that a width of the recess expands from the bottom portion toward an end on an opposite side of the bottom portion.

10. The key according to claim 1, wherein
an end of the second surface in the first direction is bent in a third direction intersecting the second surface.

11. A key of a keyboard device, the key comprising:
a key body including at least a top portion and a pair of side portions, the key body having a longitudinal dimension in a front-rear direction, and
one or more plate-like members each attached via an adhesive to at least a portion of the pair of side portions of the key body,
the top portion being divided into a first region and a second region that are contiguously formed,
the top portion in the second region protruding from a side of the top portion in the first region across the front-rear direction,
each of the one or more plate-like members being arranged such that at least a portion of an upper end surface of at least one of the one or more plate-like members faces a lower surface of the top portion in the second region, and
the top portion in the second region having a recess on the lower surface.
